(19) United States
(12) Patent Application Publication
(10) Pub. No.: US 2022/0381593 A1
(43) Pub. Date: Dec. 1, 2022

(54) METHOD FOR PRODUCING A MEASURING TUBE FOR A FLOWMETER

(71) Applicant: Endress+Hauser Flowtec AG, Reinach (CH)

(72) Inventors: Thomas Sulzer, Basel (CH); Florent Tschambser, Hesingue (FR); Lars Dreher, Ballrechten Dottingen (DE)

(21) Appl. No.: 17/755,069

(22) PCT Filed: Sep. 24, 2020
(86) PCT No.: PCT/EP2020/076672

§ 371 Date: Apr. 20, 2022

(30) Foreign Application Priority Data
Oct. 22, 2019 (DE) 10 2019 128 542.9

(51) Int. Cl. G01F 1/56; B29D 23/00

(52) U.S. Cl. CPC G01F 1/56; B29D 23/001

(57) ABSTRACT

A measuring tube includes a support tube having a metal wall surrounding a lumen, a thermoplastic liner lining the support tube and a sensor element. The liner tube has an outer diameter less than an inner diameter of the support tube, and the wall of the liner tube has a fold, such that both the lumen and a lateral surface of the liner tube have a form deviating from that of a circular cylinder. The lateral surface is curved concavely. The liner tube is positioned in the lumen and heated into a viscoelastic state and deformed such that the wall of the liner tube unfolds and presses against the wall of the support tube, such that the lateral surface is curved convexly. The liner tube is cooled and a shape is formed between the liner tube and support tube for durably securing the liner tube in the support tube.

The invention relates to a method for producing a measuring tube for a flowmeter.

In industrial measuring- and automation technology, often used for ascertaining measured values for flow- and/or substance parameters of fluids, particularly also drinking water, are flowmeters, which have at least one measuring tube. The one or more measuring tubes are inserted into the course of a process line conveying the fluid to be measured (measured substance). Each of the one or more measuring tubes is composed of an essentially hollow, cylindrical support-tube having a wall of metal, for example, stainless steel, and having, surrounded by the wall, an essentially circularly cylindrical lumen having circular cross sections, in given cases, also cross sections of different size, a liner of plastic internally lining the support-tube, and, consequently, isolating the support-tube during operation from the measured substance to be measured, and at least one sensor element applied at the support-tube for registering at least one chemical and/or physical, measured variable of the fluid conveyed in the measuring tube. Examples of such, especially magneto inductively, acoustically or vibronically measuring flowmeters are known from, among others, DE-A 10 2006 051 015, DE-A 10 2014 114 289, DE-A 10 2016 118 213, DE-A 10 2017 130 983, EP-A 1 519 160, EP-A 2 682 719, US-A 2006/0162465, US-A 2007/0295102, US-A 2010/0294043, WO-A 2006/019923 and WO-A 2016/045881. The at least one sensor element is adapted to register at least one physical and/or at least one chemical, measured variable of a fluid conveyed in the lumen of the liner-tube and to transduce such into an, especially electrical, sensor signal, namely a sensor signal, which during operation follows a change of the measured variable to be registered with a change of at least one signal parameter, for example, a signal amplitude, a signal frequency or a signal phase angle. The sensor element can, depending on principle of measurement of the flowmeter, accordingly, be, for example, an electrode for sensing an electrical potential of the fluid or, for example, an ultrasound transmitting and/or receiving, piezoelectric transducer or an electrodynamic oscillation sensor (oscillation coil).

As shown in, among others, DE-A 10 2016 118 213, DE-A 10 2014 114 289, EP-A 2 682 719, WO-A 2016/045881, such a measuring tube can be made by, firstly, positioning in the separately prefabricated support-tube in the lumen of the support-tube a likewise separately prefabricated liner-tube, namely a tubular, in given cases, also hose-like blank, having a wall of a thermoplastic plastic, for example, a polyethylene (PE). For example, the liner-tube is laid or drawn into the support-tube and the liner-tube is thereafter brought by deformation of its wall in-situ into its final (tubular-)form and at the same time secured durably with the support-tube by shape- and/or force interlocking. This deforming of the wall of the liner-tube can occur, for example, as a result of extruding (blow molding) or widening by means of a mandrel. Finally, the at least one sensor element is placed at the support-tube, for example, applied externally on its wall and/or inserted into the wall, in given cases, also in such a manner that it locally passes through the liner, and, consequently, contacts the measured substance during operation.

Although such liners can have a high chemical, thermal and mechanical durability, for example, also in such a manner that they are even suitable for use in drinking water applications, a disadvantage is that the above-described production of such a liner is actually connected with a very high technical effort; this, especially, also for the case, in which the liner is formed by means of a prefabricated liner-tube.

Starting from the above described state of the art, an object of the invention is to improve the production of measuring tubes of the type discussed by providing a simple and cost effective production of the liner.

For achieving the object, the invention resides in a method for producing a measuring tube for a flowmeter, especially for a magnetically inductive flowmeter or an ultrasound flowmeter or a vibronic flowmeter, wherein the measuring tube includes an, e.g. at least sectionally hollow cylindrical, support tube having a wall of a, for example, non-ferromagnetic, metal and having, surrounded by the wall, a, for example, at least sectionally circularly cylindrical, lumen having circular cross sections, a liner internally lining the support tube, and at least one sensor element applied at the support tube for registering at least one measured variable of a fluid conveyed in the measuring tube, which method comprises
providing the support tube;
forming the liner in the lumen of the support tube; and
applying the at least one sensor element at the support tube.

In the case of the method of the invention, the forming of the liner further comprises especially:
providing a liner tube having a wall of a thermoplastic plastic, for example, a polyethylene (PE) or a polyvinyl chloride (PVC), and a lumen surrounded thereby, wherein the liner tube has an outer diameter, which is less than an inner diameter (caliber) of the support tube, and wherein the wall of the liner tube has in a first part at least one fold, for example, a fold extending along an imaginary longitudinal axis, in such a manner that both the lumen as well as also a lateral surface of the liner tube have, in each case, a, for example, trough shaped, form deviating from that of a circular cylinder, thus non-circular, for example, c-shaped- or u-shaped-, cross sections and the lateral surface of the liner tube is curved concavely in the first part;
positioning the liner tube in the lumen of the support tube;
heating the liner tube, for example, by means of steam introduced into the lumen of the liner tube, for bringing the plastic of the wall of the liner tube into a viscoelastic state;
deforming the wall of the liner tube, in such a manner that the wall of the liner tube unfolds and presses against the wall of the support tube and the lateral surface of the liner tube is curved convexly in the first part; and
cooling the liner tube, or allowing the liner tube to cool, for bringing the plastic of the wall of the liner tube into an elastic state, in such a manner that a shape- and/or force-based interlocking is formed between liner tube and support tube for securing the liner tube durably in the support tube.

In a first embodiment, the first part of the liner tube is adapted to deform under its own power, or under action of a forming pressure in the lumen, when the thermoplastic plastic forming the wall of the liner tube is brought into the viscoelastic state, especially due to a memory-effect in the case of thermoplastic plastics. Further developing this embodiment of the invention, the deformation of the wall of the liner tube comprises a deforming of the first part of the liner tube under its own power, especially due to a memory-effect in the case of thermoplastic plastics.

In a second embodiment of the invention, the method further comprises:
bringing the plastic of the wall of a, firstly, hollow cylindrical segment of the liner tube into a viscoelastic state;
folding the first part of the wall of the segment of the liner tube, in such a manner that the lateral surface of at least the segment of the liner tube in the first part is thereafter curved concavely and both the lumen as well as also the lateral surface of at least the segment of the liner tube have, in each case, a, for example, trough shaped form deviating from a circular cylinder, thus a non-circular form, for example, with c-shaped- or u-shaped-, cross sections; and
cooling the segment of the liner tube, or allowing the segment of the liner tube to cool, for bringing the plastic of the wall of at least the segment of the liner tube into an elastic state, in such a manner that the at least one fold is formed in the first part of at least the segment.

Developing this embodiment of the invention further, it is, additionally, provided that the bringing of the plastic of the wall of the segment into the viscoelastic state comprises a heating of the segment and/or that the bringing of the plastic of the wall of the segment into the elastic state of comprises a cooling of the segment, or an allowing of the segment to cool.

In a third embodiment of the invention, the step of forming the liner includes a step of coating an adhesive on an inner surface of the wall of the support tube and/or on the lateral surface of the liner tube.

In a fourth embodiment of the invention, the method further comprises: widening at least one end, or ends, of the liner tube secured in the support tube and protruding out from the support tube, for example, for forming one or more flange seals.

In a fifth embodiment of the invention, it is, furthermore, provided that the liner tube has a length, which is greater than a length of the support tube, for example, where length of the support tube (2) amounts to more than 0.1 m and/or less than 3 m. Developing this embodiment of the invention further, it is, additionally, provided that the forming of the liner includes a shortening of the liner tube secured in the support tube.

In a sixth embodiment of the invention, it is, furthermore, provided that the support tube has a support- and holding device positioned in its lumen for the liner, wherein the support- and holding device is connected with the wall of the support tube and/or embedded therein and has, for example, a lattice shape. Developing this embodiment of the invention further, it is, additionally, provided that, for forming the liner, the wall of the liner tube is so deformed that it is pressed, at least partially, against the support- and holding device.

In a seventh embodiment of the invention, it is, furthermore, provided that the liner tube is located in an elastic state during the positioning in the support tube.

In an eighth embodiment of the invention, it is, furthermore, provided that on a first tube end of the support tube a first connecting flange is provided and on a second tube end of the support tube a second connecting flange is provided, wherein, for example, the flanges are welded to the tube ends or embodied together with the support tube as integral parts of a monolithic, formed part.

In a ninth embodiment of the invention, it is, furthermore, provided that the thermoplastic plastic of the wall of the liner tube is a polyethylene, for example, a hard polyethylene, e.g. PE 80, PE 100 or PE 100 RC.

In a tenth embodiment of the invention, it is, furthermore, provided that the at least one sensor element is formed by means of at least one electrode, for example, an electrode positioned, at least partially, also in the liner.

A basic idea of the invention is significantly to simplify the longstanding, technically very complex production of liners in flowmeters, particularly liners suitable for drinking water and/or liners provided based on a prefabricated liner tube, by manufacturing the liner according to a method actually developed for rehabilitating earth buried (drinking-)water lines, the so-called close-fit method. An advantage, among others, of the invention is that the liner-systems specially developed for application for drinking water and correspondingly available, for example, as “Wavin Compact Pipe®” of the firm, Wavin GmbH, can be applied as the liner tube in the production of the liner for the invention.

The invention as well as advantageous embodiments thereof will now be explained in greater detail based on examples of embodiments shown in the figures of the drawing. Equal, or equally acting or equally functioning, parts are provided in all figures with equal reference characters; when perspicuity requires or it otherwise appears sensible, reference characters already shown in earlier figures are omitted in subsequent figures. Other advantageous embodiments or additional developments, especially also combinations of, firstly, only individually explained aspects of the invention, result, furthermore, from the figures of the drawing and/or from claims per se.

The figures of the drawing show as follows:

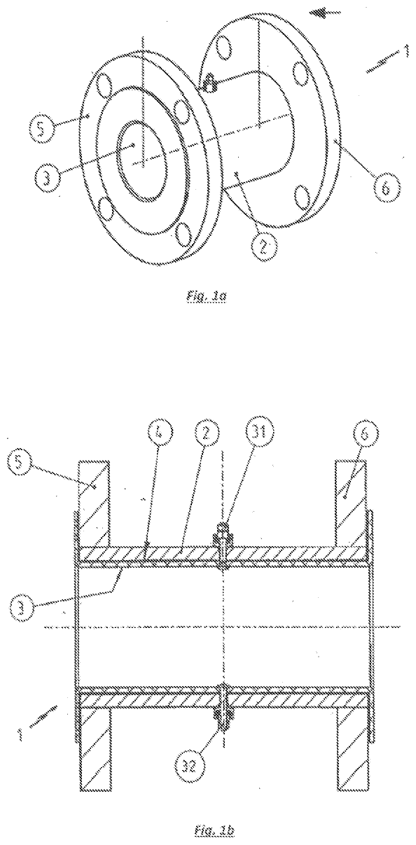

FIGS. 1a, 1b schematically in different views, a measuring tube fora flowmeter;

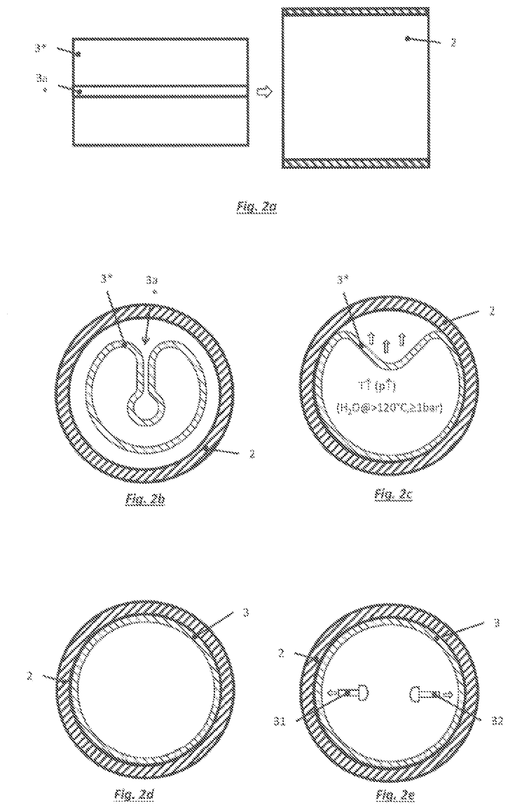

FIGS. 2a-e schematic method steps of a method of the invention for producing a measuring tube according to FIGS. 1a, 1b; and

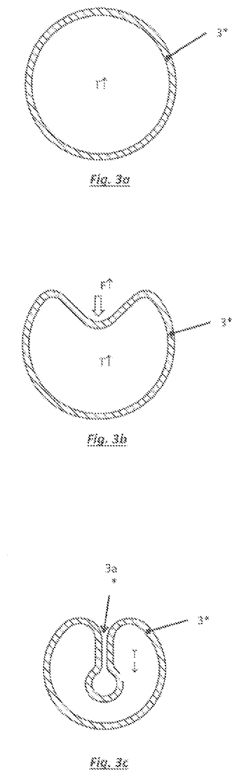

FIGS. 3a-c schematic method steps for producing a liner tube used for a method according to FIGS. 2a-e.

Shown schematically in FIGS. 1a and 1b in different views is a measuring tube 1 of a flowmeter, for example, a magnetically inductive-flowmeter or an ultrasound flowmeter or a vibronic flowmeter. The flowmeter can serve especially to measure one or more physical and/or chemical, measured variables, for example, one or more flow- and/or material parameters, of a measured substance, for example, a flowing fluid, conveyed in a pipeline (not shown). The flowmeter can, accordingly, be, for example, a flowmeter measuring a flow velocity and/or a volume flow magnetically inductively or acoustically based on ultrasound or vibronically, for example, a Coriolis mass flowmeter. The above-mentioned pipeline can be, for example, a component of a drinking water distribution network, and the measured substance can be, for example, drinking water, especially drinking water conforming to a currently valid German drinking water regulation (e.g. TrinkW 2001 as amended 2011).

The measuring tube 1 includes a support tube 2 having a wall of metal, for example, a non-ferromagnetic metal, and having a lumen surrounded thereby, as well as at least one sensor element 31 (31, 32) applied at the support tube 2 for registering the at least one measured variable of the above described measured substance.

The at least one sensor element 31 is especially adapted to register the at least one measured variable and to transduce such into an, especially electrical, measurement signal, for example, in the form of an electrical potential, or measurement voltage, dependent on the at least one measured variable. Accordingly, the at least one sensor element 31 in an additional embodiment of the invention is formed by means of at least one electrode, for example, an electrode positioned, at least partially, also in the liner 3. The sensor element 31 can, however, for example, also be an ultrasound transmitting and/or receiving, piezoelectric transducer or an electrodynamic oscillation sensor (oscillation coil). The at least one sensor element 31 can, furthermore, be electrically connected with a measuring- and operating electronics (not shown) of the flowmeter. The measuring- and operating electronics is adapted to receive and to evaluate the at least one measurement signal, for example, by using the measurement signal to ascertain measured values quantifying the at least one measured variable.

In an additional embodiment of the invention, the measuring tube 1 is provided for use in a magnetically inductive flowmeter. Accordingly, the measuring tube 1 can further comprise, arranged externally at the support tube 2, a magnetic circuit arrangement, which is adapted to produce a magnetic field, which passes through the measured substance—in such case, namely an electrically conductive liquid—flowing within the measuring tube 1 at least sectionally perpendicularly to its flow direction, in order to induce an electrical voltage in the flowing measured substance. The magnetic circuit arrangement can be formed, for example, by means of two or more field coils, which in measuring operation are electrically connected to the above described measuring- and operating electronics, wherein the measuring- and operating electronics is adapted to drive variable electrical currents of predeterminable electrical current level and direction through the field coils for effecting the magnetic field. For sensing the electrical voltage correspondingly induced in the flowing measured substance, the sensor element 31 is a first electrode and the measuring tube 1 includes, additionally, a second electrode serving as a second sensor element 32. These electrodes serving as sensor elements can, as well as also evident from FIG. 1b, be arranged, for example, diametrally opposite one another, in such a manner that a diameter of the measuring tube 1 imaginarily connecting the electrodes extends perpendicularly to a diameter of the measuring tube 1 imaginarily connecting two of the above described field coils. Alternatively, the electrodes can be so arranged on the support tube 2 that they are not diametrally opposite, for example, for the case, in which more than two electrodes are provided on the measuring tube 1, for instance, for sensing of reference potentials and/or for the monitoring of a minimum fill level in the case of a horizontally installed measuring tube 1.

In an additional embodiment of the invention, the support tube 2 is so embodied that its lumen is at least sectionally circularly cylindrical, such that its lumen has circular cross sections. The support tube 2 can, for such purpose, be embodied, for example, at least sectionally hollow cylindrically. The wall of the support tube 2 can, for example, be of a non-ferromagnetic metal, such as e.g. a non-ferromagnetic, stainless steel. For incorporating the measuring tube 1 into the above-mentioned pipeline, there can be provided, as well as also shown in FIGS. 1a and 1b, furthermore, a first connecting flange 5 on a first tube end of the support tube 2 and a second connecting flange 6 on a second tube end of the support tube 2. The flanges can, for example, be welded onto the tube ends or be embodied together with the support tube 2 as integral parts of a monolithic, formed part. Alternatively or supplementally, the wall of the support tube 2 can have lateral openings serving for accommodating the sensor element, or the sensor elements, in given cases, also recesses for accommodating the above described field coils.

For electrical insulation and/or chemical protection of the wall of the support tube 2 against the measured substance conveyed in the measuring tube during operation, the measuring tube further includes a liner 3 internally lining the support tube 2, namely a tube of an insulating material arranged in the lumen of the support tube and contacting its wall all the way around.

For producing the measuring tube 1, firstly, the support tube 2 is provided, in given cases, in the form of a semifinished part (support tube-blank), perhaps already equipped with the above described connection flanges (5, 6) and/or later to be worked still more, for example, still to be coated. Furthermore, the liner 3 is formed in the lumen of the support tube 2 and thereafter the at least one sensor element 31 (31, 32) is mounted on the support tube 2 already internally lined with the liner 3.

For forming the liner 3, a liner tube 3* having a wall of a thermoplastic plastic is used, for example, one, which is partially crystalline. As shown in FIGS. 2a, 2b and 2c, or directly evident from a combination of FIGS. 2a to d, liner tube 3* is correspondingly positioned, for example, pushed into, or laid in, the lumen of the support tube 2. The liner tube 3* is a tubular blank separately prefabricated using the above described thermoplastic plastic and having a special shape differing from that of a hollow cylinder. The plastic of the liner tube 3* is in an additional embodiment of the invention a polyvinyl chloride (PVC) or a polyethylene (PE), for example, a hard polyethylene (PE-HD), or a polyethylene with the material designation, PE 80, PE 100 or PE 100 RC. Such a polyethylene has, for instance, a usable temperature range lying between −50° C. and +80° C. and is distinguished by, among other features, a Shore hardness of approximately 64 Shore-D, a tensile strength lying between 20-30 MPa, an elastic modulus lying between 700-1200 MPa at an elongation at fracture between 20-80%, as well as a notch toughness lying, for instance, between 6-15 kJ/m².

According to the invention, the wall of the liner tube 3* has, as well as also shown schematically in FIGS. 2a and 2b, in a first part 3a* at least one fold, especially a fold extending along an imaginary longitudinal axis of the liner tube 3*, in such a manner that both an external lateral surface of the liner tube 3*, namely a lateral surface of the liner tube 3* far from the lumen of the liner tube 3*, as well as also its lumen, have, in each case, a shape deviating from a circularly cylindrical shape, for example, are grooved, or that lateral surface and lumen have, in each case, non-circular cross sections, for example, c-shaped- or u-shaped-cross sections, wherein the lateral surface of the liner tube 3* in the above described, first part is curved concavely. Used as liner tube 3*, accordingly, can be, for example, a PE tube available from the firm, Wavin GmbH (http://www.wavin.com/), under the designation, “Wavin Compact Pipe® PE 100”, or “Wavin Compact Pipe® PE 100 RC” for support tube 2 nominal diameters corresponding in such case to a caliber D₂ (inner diameter) of the support tube 2 lying between 100 mm-500 mm.

The liner tube 3* has, additionally, an outer diameter, which, as well as also directly evident from FIGS. 2a and 2b, is less than an inner diameter (caliber) of the support tube 2, whereby the positioning of the liner tube 3 in the support tube 2 is significantly simplified as compared with conventional methods of production. The first part 3a* of the liner tube 3* is, additionally, embodied, as well as also indicated in FIG. 2c, to deform in the lumen, under its own power, or under the influence of a forming pressure p, namely a slightly increased static (inner-)pressure (p>1 bar) compared with the ambient pressure (atmospheric pressure), when the thermoplastic plastic forming the wall of the liner tube 3* is brought by a supply of heat (↑T) into a viscoelastic state, namely to a forming temperature lying above its softening temperature, equally as well, below its flow temperature (melting point); this, especially, in such a manner that the wall of the liner tube, due to a transfer of molecular chains in the first part located, firstly, in stretched state into their originally balled-up state (memory-effect of thermoplastic plastics), reassumes an original, for example, hollow-cylindrical, shape. Accordingly, for the forming of the liner, the liner tube 3* positioned in the lumen of the support tube 2 is correspondingly heated, for example, by means of steam introduced into the lumen of the liner tube, especially steam having a temperature of above 120° C. and/or having a pressure of bar, in order to bring the plastic of the wall of the liner tube into the above mentioned viscoelastic state and then to deform the wall of the liner tube, or to allow it to return to an original shape, in such a manner that the wall of the liner tube unfolds and presses against the wall of the support tube and the lateral surface of the liner tube in the first part is (again) curved convexly, such that the liner tube 3 has now a completely hollow-cylindrical shape. For PE 100, for example, the softening temperature amounts to approximately 128° C. and the flow temperature to approximately 135° C., wherein the crystallites-melting point lies approximately at 130° C.

Finally, by cooling the liner tube 3*, or by allowing it to cool, the plastic of the wall of the liner tube 3* is brought (back) into an elastic state, in such a manner that a shape- and/or force-based interlocking for securing the liner tube 3* durably in the support tube 2 is formed between liner tube 3* and support tube 2, and, thus, between the liner 3 produced therewith and the support tube 2; this, in given cases, also with the interposing of a thin intermediate ply 4 (FIG. 1b) aiding in bonding liner 3 to support tube 2, namely connecting liner 3 and support tube 2 by adhesion and cohesion. Accordingly, forming of the liner 3 in the support tube 2 can include, for example, supplementally and before the positioning of the liner tube 3* in the support tube 2, also an applying of a bonding aid, or an adhesive, on an inner surface of the wall of the support tube 2 and/or on the lateral surface of the liner tube 3* as well as a curing, or allowing to cure, of the (applied) bonding aid, or adhesive, following the unfurling of the liner tube 3*, for the forming of the above described intermediate ply 4. Alternatively or supplementally, the support tube 2 can, for the purpose of improving the mechanical stability of the liner 3 and/or the shape-, or force, interlocking, have, positioned in the lumen of the support tube 2 and connected with the wall and/or molded into the wall, a, for example, lattice shaped, support- and holding device (support body) (not shown) for the liner 3, wherein for the forming of the liner 3 the wall of the liner tube 3* is then also so deformed that it is pressed, at least partially, against the support- and holding device.

Serving as starting material for the liner tube 3* can be, for example, a hollow cylindrical, in given cases, even hose-like, (plastic-)tube (FIG. 3a) of the above described thermoplastic plastic. For the purpose of forming of the above described fold in the first part 3a* of the liner tube 3* in an additional embodiment of the invention, preliminarily, namely before the forming of the liner 3 in the support tube 2, the plastic of the wall of a, firstly, hollow cylindrical segment of the liner tube 3*, namely a corresponding segment of the plastic tube serving ultimately as a liner tube 3*, is transformed into a viscoelastic state, for example, brought, as a result of heating, from an elastic state into the viscoelastic state, or by cooling, or allowing to cool, brought from a viscous state into the viscoelastic state. As shown schematically in FIG. 3b, the first part of the wall of the segment of the liner tube 3* (now in the viscoelastic state) is then folded by providing corresponding forces (↑F), in such a manner that, as well as also evident from FIG. 3c, the lateral surface of at least the segment 3a* in the first part is thereafter curved concavely and both the lumen as well as also the lateral surface of at least the segment, in each case, has a cross section deviating from a circular cylinder, thus, for example, has a trough shaped form, thus a non-circular, for example, c-shaped- or u-shaped-form; this, especially, in such a manner that—such as already mentioned—molecular chains in a balled state in the first part are transformed into a stretched state, whereby the memory-effect is brought about. Then, the so formed segment of the liner tube is again, or further, cooled, or allowed to cool, in order to bring the plastic of the wall of at least the segment of the liner tube into an elastic state, in such a manner that the at least one fold in the first part of at least the segment is retained; this, especially, in such a manner that the molecular chains are frozen and maintained in the forced, stretched state, whereby the mechanical stresses serving in the first part for bringing about the restoring forces required for the later forming of the liner tube 3* are stored as residual stresses. This production of a liner tube with a significant length amounting, in given cases, even to multiples of 10 m can occur, for example, in a machine involving an extruder outputting to a folding unit arranged with cooling oven and receiving the length of tube delivered from the extruder and correspondingly forming it.

In an additional embodiment of the invention, it is, furthermore, provided that the liner tube 3* has a length, which is greater than a length of the support tube 2, wherein the length of the support tube 2 amounts, for example, to more than 0.1 m and/or less than 3 m. For forming the liner 3, it can, accordingly, also be necessary subsequently to shorten the liner tube 3* secured in the support tube 2, for example, to remove its ends protruding out from the support tube 2, in given cases, even to remove them flushly, especially to cut or saw them off. Alternatively or supplementally, the protruding ends of the liner tube 3* (located in the viscoselastic- or viscous state, or mixtures thereof) can also be widened by means of a corresponding pressing tool, for example, in order for the above described case, in which connecting flanges 5, 6 are provided on the support tube 2, then, in each case, also to form a corresponding flange seal by means of the liner tube 3*.

The space between the connection flanges 5, 6 and the support tube 2 can—such as quite usual particularly in the case of magnetically inductive flowmeters or in the case of ultrasound flowmeters—be enclosed by means of an enclosure of sheet metal, for example, using a magnetic field shielding metal, to form a protective housing.

1-13. (canceled)

14. A method for producing a measuring tube for a flowmeter, wherein the measuring tube includes a support tube having a metal wall, a circularly cylindrical lumen surrounded by the wall, and a liner internally lining the support tube, as well as at least one sensor element applied at the support tube for registering at least one measured variable of a fluid conveyed in the measuring tube, which method comprises:
providing the support tube;
forming the liner in the lumen of the support tube; and
applying the at least one sensor element at the support tube;
wherein the forming of the liner comprises:
providing a liner tube having a wall of a thermoplastic plastic and a lumen surrounded thereby;
wherein the liner tube has an outer diameter, which is less than an inner diameter of the support tube; and
wherein the wall of the liner tube has in a first part at least one fold, in such a manner that both the lumen as well as also a lateral surface of the liner tube have a form deviating from that of a circular cylinder and, thus, a non-circular form, and the lateral surface of the liner tube is curved concavely in the first part;
positioning the liner tube in the lumen of the support tube;
heating the liner tube for bringing the plastic of the wall of the liner tube into a viscoelastic state;
deforming the wall of the liner tube, in such a manner that the wall of the liner tube unfolds and presses against the wall of the support tube, and the lateral surface of the liner tube is curved convexly in the first part; and
cooling the liner tube, or allowing the liner tube to cool, for bringing the plastic of the wall of the liner tube into an elastic state, in such a manner that a shape and/or force-based interlocking is formed between liner tube and support tube for securing the liner tube durably in the support tube.

15. The method of claim 14, wherein the first part of the liner tube is adapted to deform under its own power, or under action of a forming pressure in the lumen, when the thermoplastic plastic forming the wall of the liner tube is brought into the viscoelastic state.

16. The method of claim 14, wherein the deformation of the wall of the liner tube comprises a deforming of the first part of the liner tube under its own power.

17. The method of claim 14, further comprising:
bringing the plastic of the wall of a, firstly, hollow cylindrical segment of the liner tube into a viscoelastic state;
folding the first part of the wall of the segment of the liner tube, in such a manner that the lateral surface of at least the segment of the liner tube in the first part is thereafter curved concavely, and both the lumen as well as also the lateral surface of at least the segment of the liner tube have, in each case, a form deviating from that of a circular cylinder and, thus, a non-circular form; and
cooling the segment of the liner tube or allowing the segment of the liner tube to cool, for bringing the plastic of the wall of at least the segment of the liner tube into an elastic state, in such a manner that the at least one fold is formed in the first part of at least the segment.

18. The method of claim 14, wherein the bringing of the plastic of the wall of the segment into the viscoelastic state comprises a heating of the segment; and/or the bringing of the plastic of the wall of the segment into the viscoelastic state comprises a cooling of the segment, or an allowing of the segment to cool.

19. The method of claim 14, wherein the liner tube is located in an elastic state during the positioning in the support tube.

20. The method of claim 14, wherein the step of forming the liner includes a step of coating an adhesive on an inner surface of the wall of the support tube and/or on the lateral surface of the liner tube.

21. The method of claim 14, wherein the liner tube has a length, which is greater than a length of the support tube.

22. The method of claim 14, wherein forming of the liner includes a shortening of the liner tube secured in the support tube.

23. The method of claim 14, wherein on a first tube end of the support tube a first connecting flange is provided and on a second tube end of the support tube a second connecting flange is provided.

24. The method of claim 14, further comprising widening at least one end, or ends, of the liner tube secured in the support tube and protruding out from the support tube.

25. The method of claim 14, wherein the support tube has a support and holding device positioned in its lumen for the liner, wherein the support and holding device is connected with the wall of the support tube and/or embedded therein and has, especially, a lattice shape, and wherein, for forming the liner, the wall of the liner tube is so deformed that it is pressed, at least partially, against the support and holding device.

26. The method of claim 14, wherein the thermoplastic plastic of the wall of the liner tube is a polyethylene, and/or wherein the at least one sensor element is formed using at least one electrode.
